(19) United States
(12) Patent Application Publication
(10) Pub. No.: US 2015/0266256 A1
(43) Pub. Date: Sep. 24, 2015

(54) FOLDING MACHINE AS COMBINED KNIFE AND BUCKLE FOLDERS

(71) Applicant: T.S.D. LLC, SEBASTIAN, FL (US)

(72) Inventor: LEO A. HAYDT, III, SEBASTIAN, FL (US)

(21) Appl. No.: 14/730,567

(22) Filed: Jun. 4, 2015

Related U.S. Application Data
(63) Continuation-in-part of application No. 13/972,972, filed on Aug. 22, 2013.

(51) Int. Cl. B31F 1/00

(52) U.S. Cl. CPC B31F 1/0012

(57) ABSTRACT

A folding machine includes an accumulator that accumulates at least one sheet of flexible substrate material. A knife folder is adjacent the accumulator and has a knife fold plate that receives the sheet and a knife blade that reciprocates against the sheet. Buckle fold drive rollers are adjacent the knife folder and receive the sheet driven from the knife blade to form a knife fold. At least one buckle folder is oriented along the buckle fold drive rollers and receives a knife fold to form a buckle fold in the sheet. A buckle folder receives the knife fold to form a buckle fold. A sheet engages an end stop in the buckle folder. A biasing mechanism engages the end stop to allow biasing movement of the end stop to assist movement of the sheet in and out of the buckle folder.

### RELATED APPLICATION(S)

This is a continuation-in-part application of U.S. patent application Ser. No. 13/972,972 filed on Aug. 22, 2013, the disclosure which is hereby incorporated by reference in its entirety.

### FIELD OF THE INVENTION

The present invention relates to a folding machine, and more particularly, this invention relates to a folding machine that combines a knife folder and at least one buckle folder.

### BACKGROUND OF THE INVENTION

Folding machines use a tool or other mechanical pressure to create a sharply defined crease into a sheet of flexible substrate material such as paper. Although there are many different types of folding machines, the more common techniques include knife folding and buckle folding, also referred to as buckle plate folding.

In a knife folder, a sheet of flexible substrate material is fed along a conveyor or other belt above fold rollers until the sheet collides with an end stop, halting movement of the sheet. A knife then pushes the sheet into a nip between the fold rollers. Knife folding is usually a static process since the sheet is stationary before the reciprocating knife forces the sheet into the nip between the fold rollers, which are usually set to the thickness of the sheet. As the sheet passes through these rollers, it is pinched and the fold is formed. One knife is usually used at any one folding station. With subsequent folds, the folded sheet is passed into another knife folding station at right angles to the preceeding folding station. Knife folders are often used with printers and binders specializing in folding large, single sheets.

Buckle folding uses a plurality of rollers and a buckle plate. A buckle folder usually includes at least one buckle plate and rollers that feed an incoming sheet into a buckle plate until it reaches an adjustable feed stop. As the leading edge of the sheet strikes the stop, the sheet continues to be fed into the buckle plate, creating a buckle in a space between feed rollers. As excess paper is driven downward, it is grabbed by other rollers and the fold is formed as the sheet passes through them. Buckle folding is not restricted to any cyclical movement, which makes it ideal for high-speed folding. Each buckle folding station can include a number of buckle plates, arranged alternately above and below, allowing for complex folds. The term buckle plate for a buckle folder may refer to opposing plates that are spaced from each other that form a “chute” into which the sheet is driven and stopped by the adjustable feed stop.

Some folding machines may use a traditional knife folder to fold a large sheet and convey that folded sheet downstream into a traditional buckle folder. These types of folding systems work with a single page and not multiple pages as a page set. A difficult part of folding in a buckle folder a page set with multiple sheets as compared to folding an individual sheet is the formation of the first fold. As a result, buckle folders are usually used for high-speed folding of single sheets to permit a large number of fold variations. When multiple pages as in a large page set are folded, the more difficult part of folding these multiple sheets is the first fold in a buckle folder, as compared to a knife folder that allows a knife to be pressed forcibly against a page set.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

In accordance with a non-limiting example, the folding machine incorporates a knife fold and multiple buckle folds. In a preferred embodiment, the machine accumulates more than one sheet of flexible substrate material in a page set. The folding machine initiates a first fold with a knife on the same plane as a traditional buckle folder and permits combination knife and buckle folding of accumulated page sets. A page set is accumulated against a knife fold plate and the knife blade forces the page set into the buckle fold drive rollers that form the buckle folder.

It is important that the address to which the label or address as pre-printed exits a buckle folder correctly with different applications. In-line units feed paper and the bucket folders receive sheets that may be multiple sheets forming a page set. The page sets are fed at high speed and it is important that the page set moves in and out of the bucket folder in an efficient manner. Some folding machines in the industry include leaf type springs positioned in a fold plate. The folding machine as described below addresses this technical issue.

The folding machine in one example includes an accumulator that accumulates at least one sheet of flexible substrate material. A knife folder is adjacent the accumulator and has a knife fold plate that receives the at least one sheet and a knife blade that reciprocates against the at least one sheet. Buckle fold drive rollers are adjacent the knife folder and receive the at least one sheet driven from the knife blade to form a knife fold. At least one buckle folder is oriented along the buckle fold drive rollers and receives the knife fold to form a buckle fold in the at least one sheet. The at least one buckle folder includes an end stop onto which the at least one sheet engages such that at least one sheet buckles into adjacent buckle fold drive rollers and form a buckle fold. A biasing mechanism engages the end stop to allow biasing movement of the end stop as the at least one sheet engages the end stop to assist movement of the at least one sheet in and out of the buckle folder.

In one example, the biasing mechanism may be formed as a spring engaging the end stop. In another embodiment, the end stop is formed as an end stop bar onto which the at least one sheet engages as the sheet enters the buckle folder. In another example, the folding machine includes at least one rod supporting the end stop bar from movement along the rod.

In one example, more than one sheet is accumulated against a knife fold plate to form a page set that is knife folded into the buckle fold drive rollers. A first collector receives the page set after folding and a second collector receives a subset that had been folded separately and is collected. The first and second collectors are configured to merge the subset with the page set.

In another example, a plurality of buckle folders are oriented along the buckle fold drive rollers and selected to receive and fold the at least one sheet to form successive buckle folds. Each buckle folder includes a pivotally mounted deflector normally in a position to deflect a sheet from entering a respective buckle folder and which is pivoted away to allow a sheet to enter a buckle folder to be buckle folded. In another example, each buckle folder comprises opposing buckle plates that receive the at least one sheet between the opposing plates. A deflector may be pivotally mounted on one of the buckle plates that is normally in a position to deflect the sheet away from the buckle folder and pivoted out of position adjacent the buckle fold drive rollers to allow a sheet to enter the buckle folder between the plates. A shuttle separates a plurality of sheets into the accumulator in another example.

A method of folding sheets of flexible substrate material includes feeding at least one sheet against a knife fold plate. A knife is driven against the at least one sheet into buckle fold drive rollers to form a knife fold, which is driven by the buckle fold drive rollers into at least one buckle folder to form a buckle fold while engaging the at least one sheet against an end stop within the buckle folder and biasing the end stop for assisting movement of the at least one sheet in and out of the buckle folder. A plurality of buckle folders are oriented along the buckle fold drive rollers and buckle fold the at least one sheet to form successive folds. A buckle folder is selected in one example by pivoting a deflector away from adjacent the buckle fold drive rollers to allow a sheet to pass into the buckle folder.

In one example, each buckle folder comprises opposing buckle plates that receive the at least one sheet between the plates, an end stop that causes the at least one sheet to buckle into adjacent buckle fold drive rollers to form a buckle fold, and a deflector pivotally mounted on one of the buckle plates that is normally in a position to deflect a sheet away from a buckle folder and pivoted out of position adjacent the buckle fold drive rollers to allow a sheet to pass into the buckle folder.

In another example, more than one sheet may be accumulated to form a page set that is knife folded into the buckle fold drive rollers. Each page set can be collected into a first collector. At least one sheet may be folded separately as a subset and collected at a second collector. The subset is merged within the page set in another example. More than one sheet may be accumulated against the knife fold plate and a shuttle may separate a plurality of sheets into an accumulator.

### BRIEF DESCRIPTION OF THE DRAWINGS

Other objects, features and advantages of the present invention will become apparent from the detailed description of the invention which follows, when considered in light of the accompanying drawings in which:

FIG. 1 is a fragmentary plan view of the folding machine showing basic components in accordance with a non-limiting example.

FIG. 2 is a fragmentary, rear elevation view of the folding machine showing basic components in accordance with a non-limiting example.

FIG. 3 is a fragmentary side elevation view of the folding machine showing basic components in accordance with a non-limiting example.

FIG. 4 is another fragmentary side elevation view showing the knife folder, buckle fold drive rollers, the buckle folders oriented along the buckle fold drive rollers, and deflector positioned at each buckle folder in accordance with a non-limiting example.

FIG. 5 is another fragmentary side elevation view similar to FIG. 4 and showing an example of using the knife folder and a selected buckle folder to form a letter fold.

FIG. 6 is another fragmentary side elevation view similar to FIG. 5 and showing an example of using another selected buckle folder to form another type of letter fold.

FIG. 7 is another fragmentary side elevation view similar to FIG. 4 showing an example of using selected buckle folders to form a double parallel fold in accordance with a non-limiting example.

FIG. 8 is another fragmentary side elevation view similar to FIG. 4 and showing an example of using selected buckle folders to form a double parallel fold in accordance with a non-limiting example.

FIG. 9 is an isometric view of the folding machine showing various components in accordance with a non-limiting example.

FIG. 10 is another isometric view of the folding machine similar to that shown in FIG. 9 and showing a paper stack loaded into the machine.

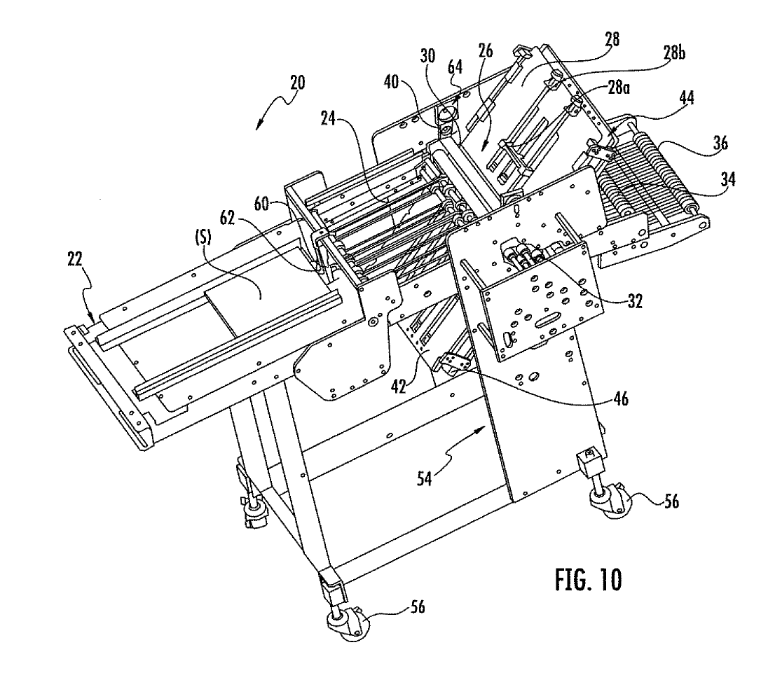

FIG. 11 is an enlarged isometric view showing the knife folder and accumulator in accordance with a non-limiting example.

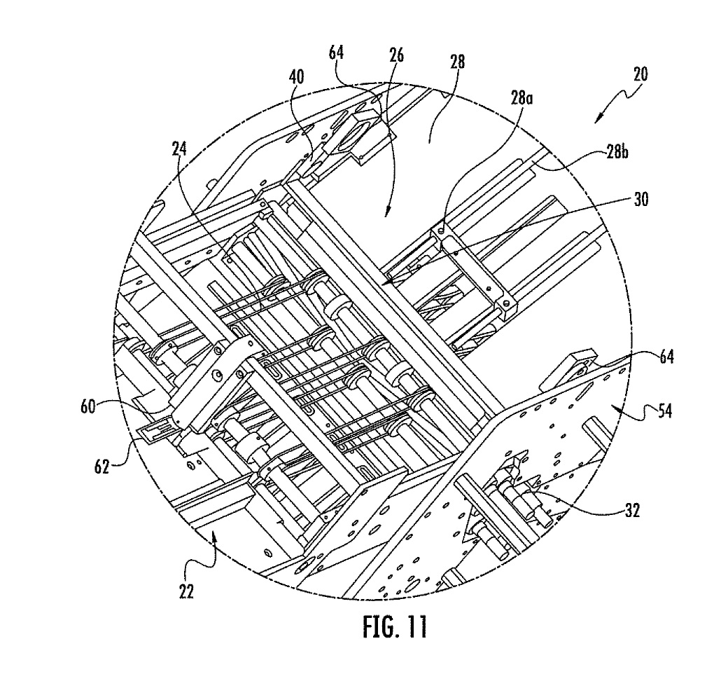

FIG. 12 is another enlarged isometric view similar to that shown in FIG. 11 and showing at least one sheet such as a page set contained in the accumulator before knife folding in accordance with a non-limiting example.

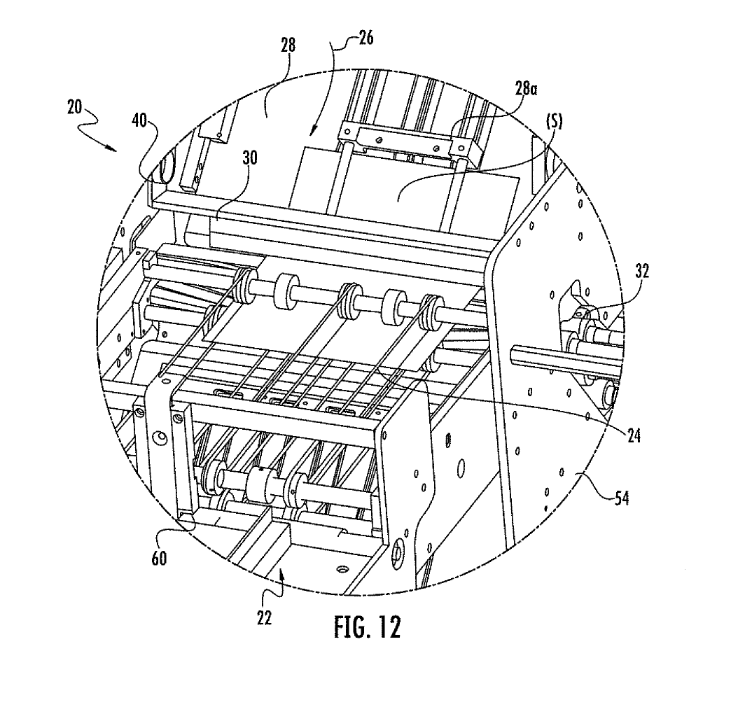

FIG. 13 is an enlarged isometric view of a portion of the folding machine showing the first and second collectors.

FIG. 14 is another enlarged isometric view similar to that shown in FIG. 13 and showing at least one sheet with a completed letter fold.

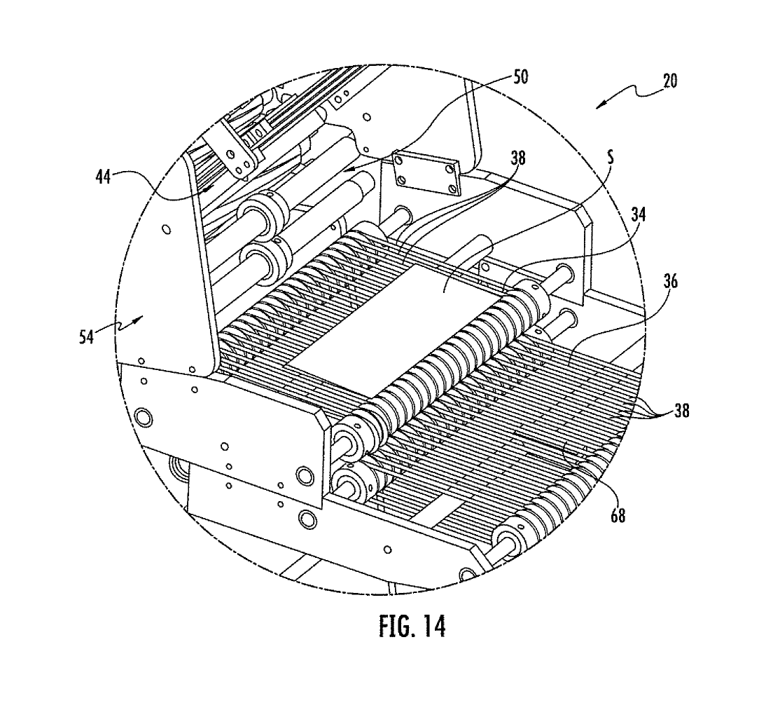

FIG. 15 is a high-level flowchart showing a sequence of operations for the folding machine in accordance with a non-limiting example.

FIG. 16 is an enlarged isometric view of a bucket folder showing the end stop and biasing mechanism.

FIG. 17 is an isometric view of the end stop formed as an end stop bar and rods supporting the end stop bar for movement along the rods.

### DETAILED DESCRIPTION OF THE PREFERRED EMBODIMENTS

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

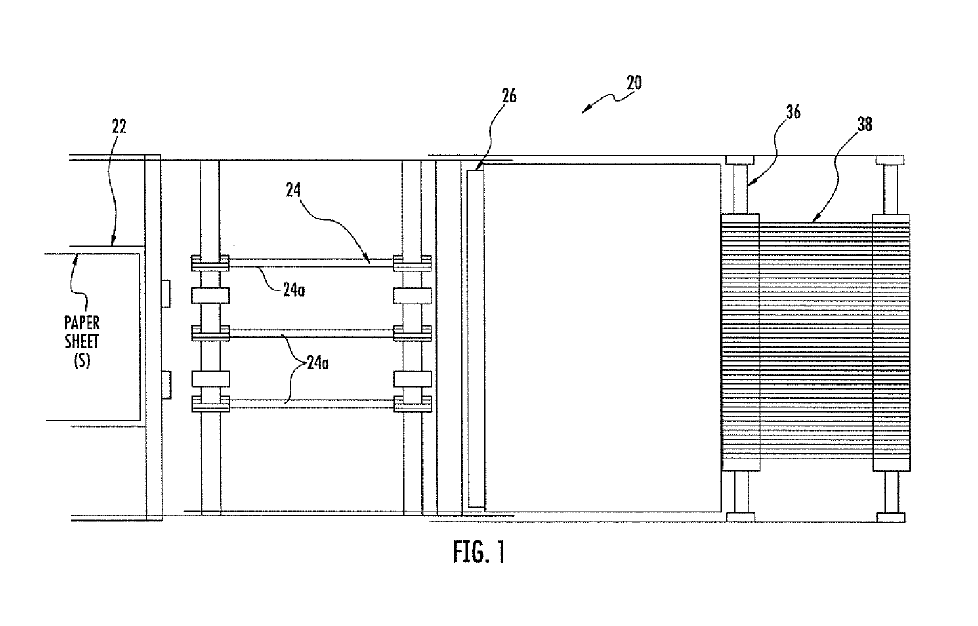

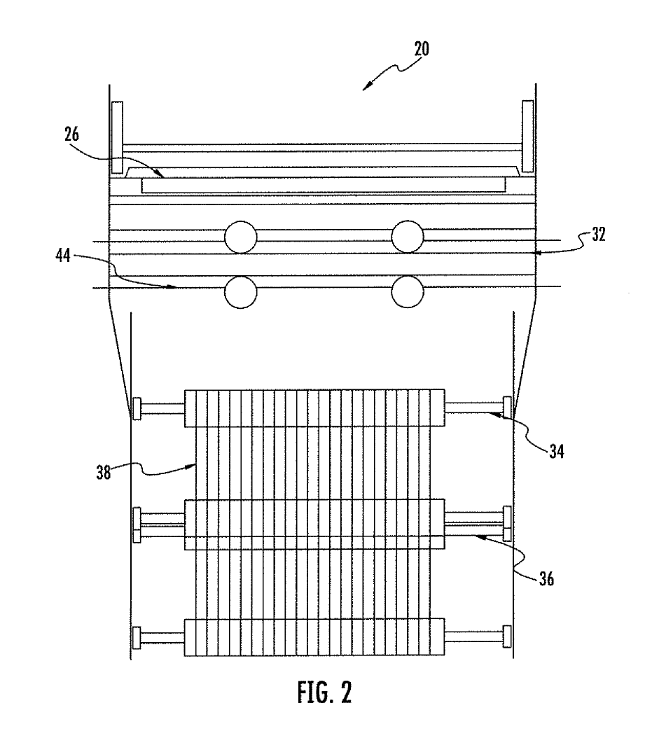

FIG. 1 is a plan view of the folding machine 20 showing its basic components, including a vacuum shuttle feed 22 used for document separation of sheets of flexible substrate material. A sheet(s) of flexible substrate material is shown on the vacuum shuttle feed 22 and is fed into an accumulator 24, also referred to by some skilled in the art as an accumulator transport. The accumulator 24 feeds the sheet into a knife folder 26 that includes a knife fold plate 28 that receives the at least one sheet and a knife blade 30 that is driven against the at least one sheet into a series of buckle fold drive rollers 32 (FIG. 2) to form a knife fold in the at least one sheet(s).

As shown in the fragmentary elevation view of FIG. 2, a first collector 34 and a second collector 36 are shown that collect the folded sheets. In an example, more than one sheet may be accumulated to form a page set that is knife folded into the buckle fold drive rollers 32. The page set as multiple sheets may then be buckle folded to form different complex folds depending on which buckle folder is selected to reserve a page set and fold it as explained below. The page set once folded may be collected into the first collector 34. At least one sheet may be folded separately as a subset and collected at the second collector 36 and then merged with the page set. An example could include folded insurance brochures that are merged with a cover letter that may be folded separately. The brochures could pertain to a specific matter and would be collected at the first collector and the cover letter for an individual would come down over it to be merged. This cover letter as a subset had been folded separately.

FIG. 2 is another fragmentary elevation view showing the first and second collectors 32, 34 and the round belts 38 that form the collectors. The knife folder 26 includes the knife fold plate 28 that initiates the first fold and buckle fold drive rollers 32 that drive that first knife fold into buckle folders, and more particularly, which include three buckle folders 42, 44, 46 adjacent the drive rollers that are individually selected as explained below to receive a page set and buckle fold the page set after knife folding.

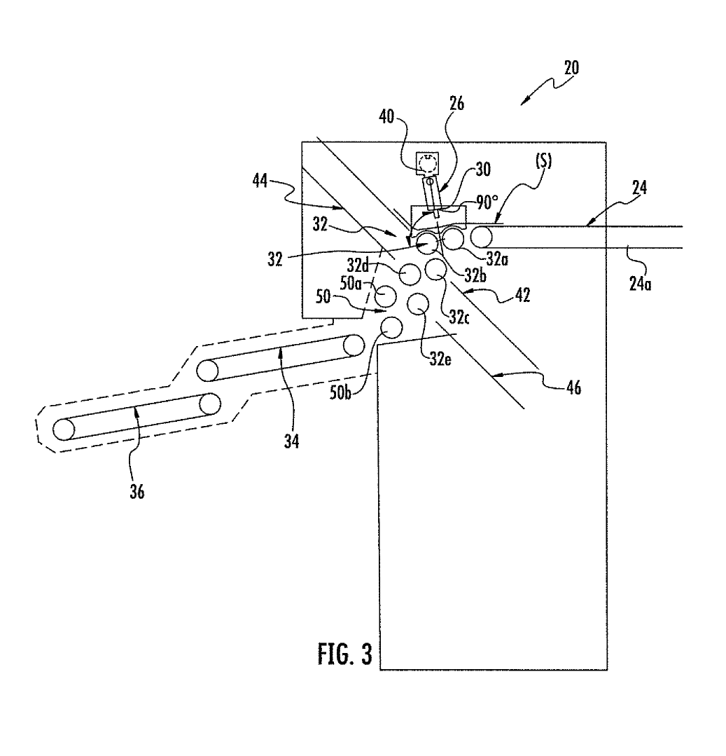

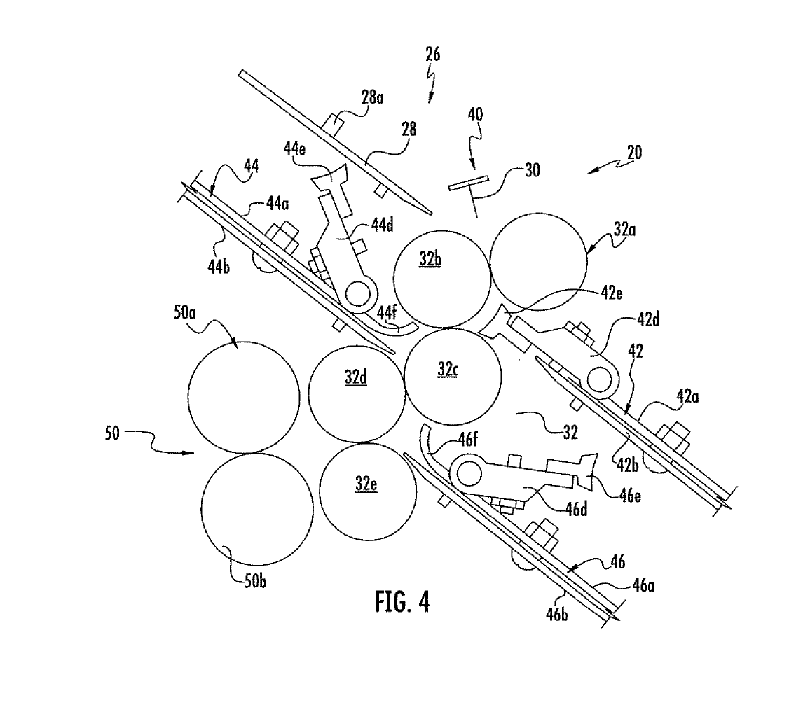

FIG. 3 is a fragmentary side elevation view showing the accumulator 24 and at least one sheet(s) as accumulated at the knife folder 26. A piston or other drive mechanism 40 engages the knife blade 30 and drives the knife blade into the sheet to initiate the first fold. The knife blade 30 drives that knife fold into the buckle fold drive rollers that include a stationary main roller 32a and four buckle fold drive rollers 32b-e that receive a sheet that has been knife folded after engaging with the knife fold plate 28 as shown in greater detail in FIG. 4.

In the fragmentary side elevation view of FIG. 3, the accumulator 24 is shown adjacent the knife folder 26 and accumulates a sheet of flexible substrate material such as paper under the knife blade 30 and initiates the first fold. The knife fold plate 28 is shown schematically together with the first, second and third buckle folders 42, 44, 46 that are positioned adjacent the buckle fold drive rollers 32 as illustrated. The rollers are offset to each other. The buckle folders 42, 44, 46 are illustrated schematically as buckle fold plates. A pull-out roller assembly 50 having rollers 50a and 50b will pull the paper to be collected within the first and second collectors 34, 36.

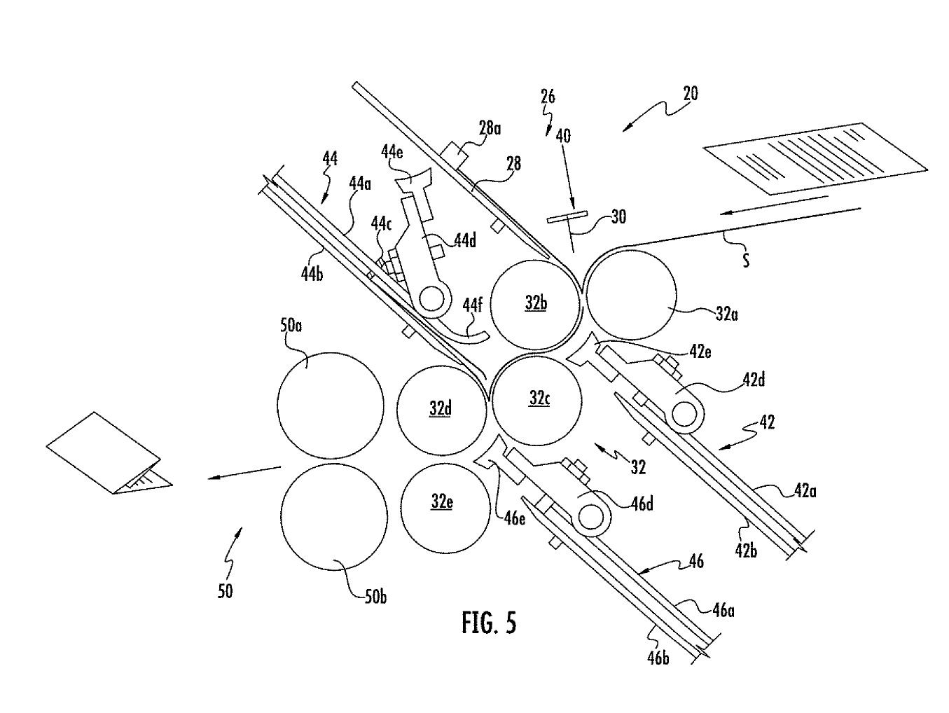

FIG. 4 shows greater details of the buckle folders 42, 44, 46 and knife fold plate 28 that includes the stop 28a. Each buckle folder includes at least one buckle plate, and as illustrated, opposing buckle plates 42a, 42b, 44a, 44b, 46a, 46b that form a “chute” to receive at least one sheet and an end stop 44c (FIG. 5) that causes at least one received sheet to stop when driven between the plates to buckle the sheet into an adjacent buckle roll drive rollers 32 and form a buckle fold. A deflector 42d, 44d, 46d is illustrated as pivotally mounted on the top buckle plate 42a, 44a, 46a and is pivoted into and out of position adjacent the buckle roll drive rollers 32. When the deflector 44d is pivoted away from the buckle roll drive rollers 32, a sheet is free to pass between the buckle plates 44a, 44b into the buckle folder 44 as shown in the example of the second buckle folder 44 in FIG. 5. Each buckle folder 44, 44, 46 as noted before is formed as opposing plates that includes a top plate 42a, 44a, 46a that pivotally mounts the deflectors 42d, 44d, 46d. When the deflector 44d of the second buckle folder is deflected away as shown in FIG. 5, a sheet passes between the opposing buckle plates 44a, 44b. Otherwise, when a deflector is down, the sheet will be deflected off the end deflector portion 42e, 44e, 46e of the respective deflector into the next series of buckle fold drive rollers. An example is shown in FIG. 5 and a letter fold is formed when the second buckle folder 44 has its deflector 44d positioned away from the buckle fold drive rollers 32.

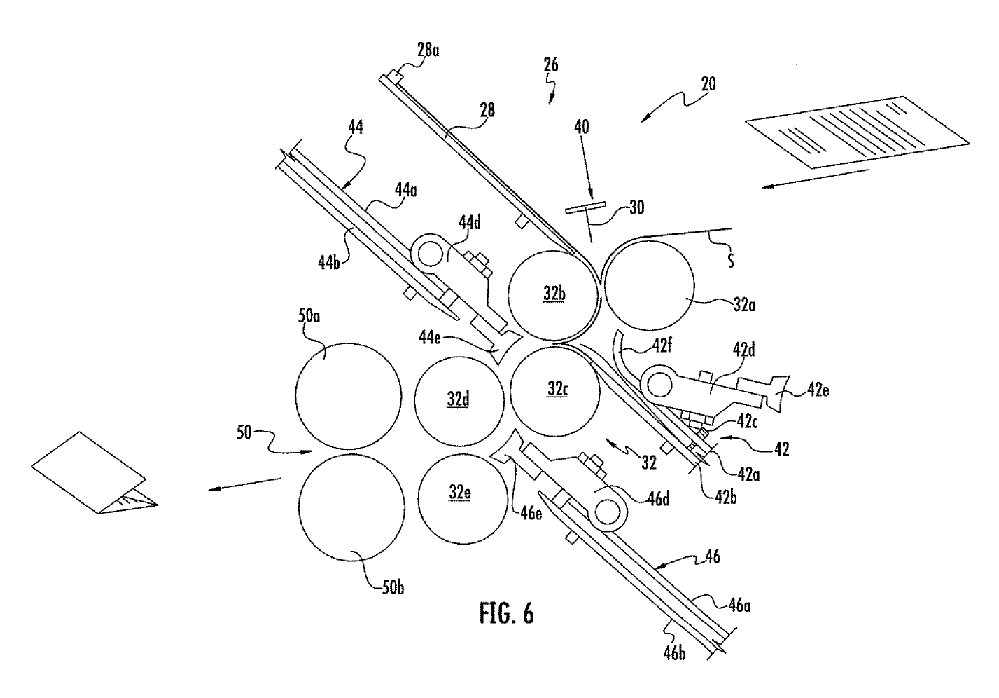

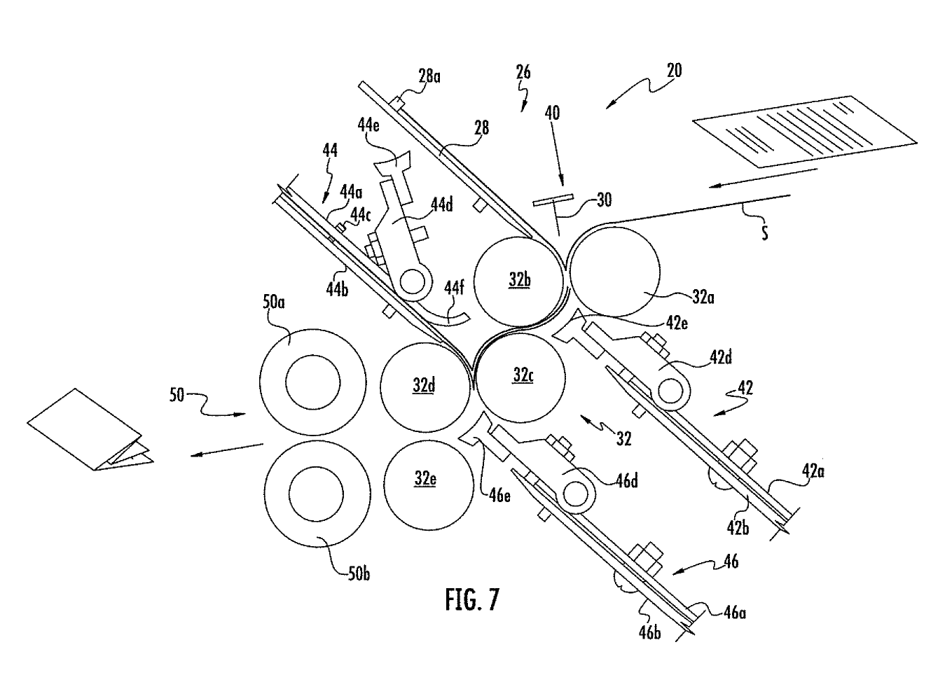

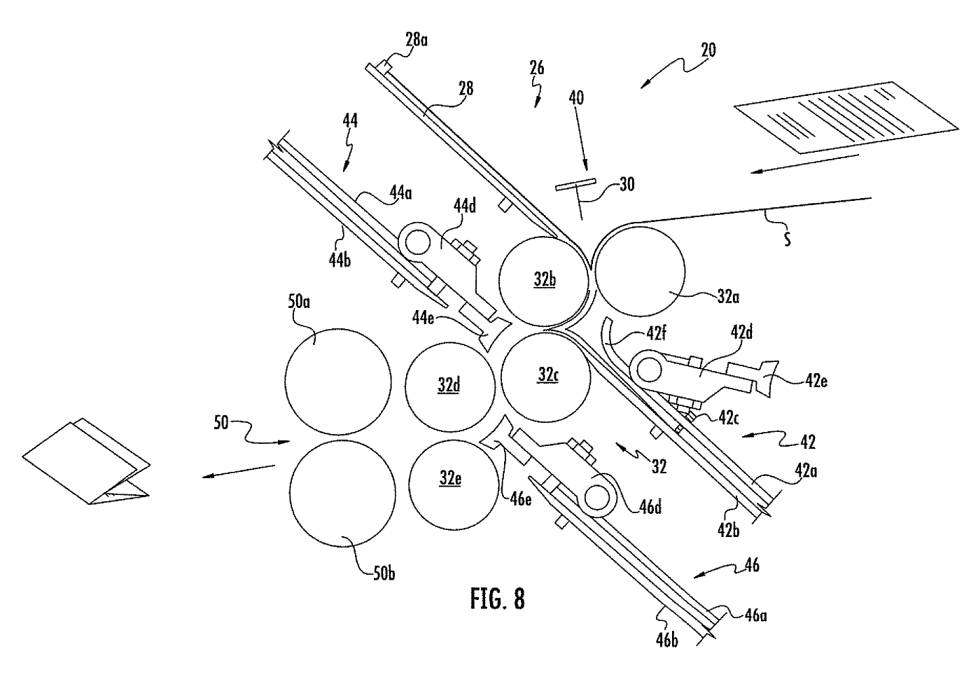

FIG. 6 shows an example of the first buckle folder 42 having its deflector 42d pivoted away to form another type of letter fold in the sheet, while FIG. 7 shows the deflector 44d in the second buckle folder 44 pivoted away to form a double parallel fold in the sheet. FIG. 8 shows the deflector 42d in the first buckle folder 42 deflected away to form a double parallel fold. The buckle folders are selected depending on the specific buckle folds to be made in a sheet to form complex fold patterns. When the deflectors 42d, 44d, 46d are pivoted away, a curved guide 42f, 44f, 46f is formed to guide a sheet into the “chute” formed at the respective folder.

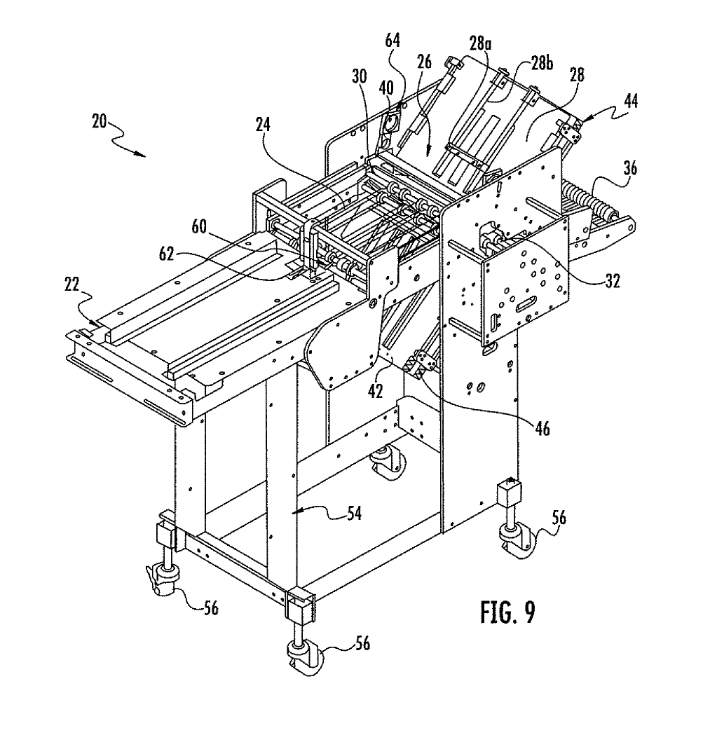

FIG. 9 is an isometric view of the folding machine showing the various components. The folding machine 54 is a compact unit with all components mounted on the frame that is supported by castered wheels 56 and a steel frame construction as illustrated. The folding machine 54 is readily moveable to be positioned near other ancillary devices such as sheet feeders and mailing systems.

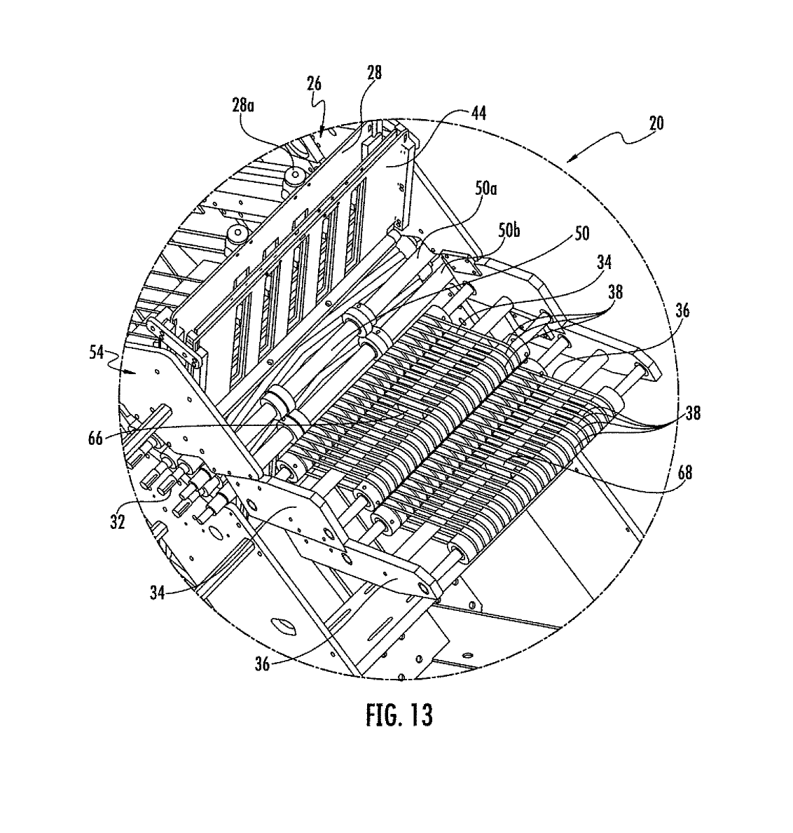

Various sensors are used during the sheet folding operations. A paper feed sensor 60 is shown in FIG. 9 that reads the type and number of sheets that the vacuum shuttle feed 22 moves into the accumulator 24. A vacuum shuttle feed sensor 62 shown in FIG. 9 reads the shuttle for the home position. A knife blade sensor 64 shown in FIG. 1 reads the knife blade 30 with the knife folder 26 for its home position. Collector sensors 66, 68 for respective first and second collectors 34, 36 are shown in FIG. 13 and will sense if a sheet or other paper is present within the respective collectors.

The folding machine 54 is made from thin plates fabricated together, such as thin steel plate. The vacuum shuttle feed 22 includes a plurality of vacuum ports in its surface to retain one or more sheets and feed them into the accumulator 24 that is formed from a plurality of accumulator belts 24a as illustrated that feed a sheet onto the knife fold plate 28. One or more sheets may be fed and a plurality of sheets form a page set as explained above. Various servomotors may be used to drive the various shafts that hold the pulley belts. Appropriate servomotors connect into various drive shafts that hold the different belts for the accumulator and the drive rollers that form the buckle fold drive rollers. Appropriate spacers can vary the spacing between the different buckle fold plates that form the buckle folders and the stops are adjustable. The stop 28a on the knife fold plate 28 is adjustable through adjustment rods 28b as shown in FIG. 9. The dimensions of the various rollers, belts, buckle folders and knife folder depend on the type of sheets that will be processed, but typically will vary depending on the requirements of those skilled in the art and the production runs. Various combinations for different sizes can be made through adjustment screws and separators that are positioned in the buckle folders to accommodate different sheets and page sets.

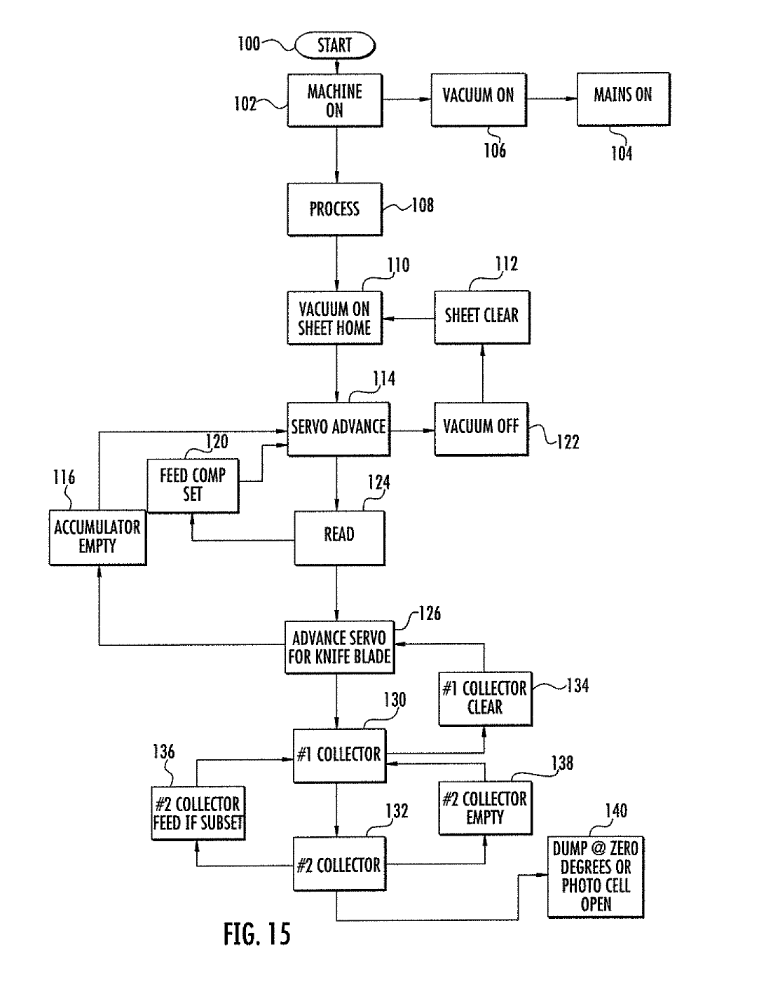

FIG. 15 is a flowchart showing a basic sequence of operation. The process starts (Block 100) with the machine on (Block 102). This function is a result of turning on the main power (Block 104) and the vacuum on (Block 106) and turns on a vacuum pump, a main sheet folder motor and applies power to different server controllers and DC power supplies as used to operate the vacuum shuttle feed, accumulator, knife folder, collectors and other components. The process begins (Block 108) and this function allows the paper to advance and fill all stations within the system. The operator is instructed to fill the machine with paper to be processed or other sheets that could form a page set prior to depressing the process button on a control panel. The vacuum on and sheet home (Block 110) will be activated on by a servomotor controller in the home position and a “sheet clear” (Block 112) photo cell is satisfied such as for the paper feed sensor and vacuum shuttle feed sensor.

The server advance function (Block 114) will be controlled by an optical reader and the controller by three conditions as illustrated, e.g., an accumulator empty (Block 116), a read component that allows set to feed until complete, and a feeds by a preset count (Block 120) using the sheet clear photo cell to count sheets. A vacuum off condition (Block 122) will be controlled by the servomotor reaching its full stroke and determining if a sheet is clear. The read (Block 124) will incorporate an optical reader that determines the complete set due to information printed on the document on special database driven for inserting. A signal for the advanced servomotor for the knife blade occurs (Block 126) when the page count reaches its determined set size and the servomotor for the knife blade will complete a full cycle to start the folding process.

When a photo cell is satisfied, the software will control to push any material from collector 1 (Block 130) to collector 2 (Block 132) when a determination is made that collector 2 is empty. There is a loop back if collector 1 is clear (Block 134) and needs to feed and complete the page set in a subset condition (Block 136) such as in the insurance example described above. The system will feed back to the first collector if the second collector is empty (Block 138). For collector 2 (Block 140), software will control the different conditions and will dump at zero degrees into an inserting machine or conveyor for offline use. A single set may be dumped or a completed subset will be dumped into a track of the inserting machine at zero degrees or dumped onto a conveyor after the photo cell has been cleared. The process repeats.

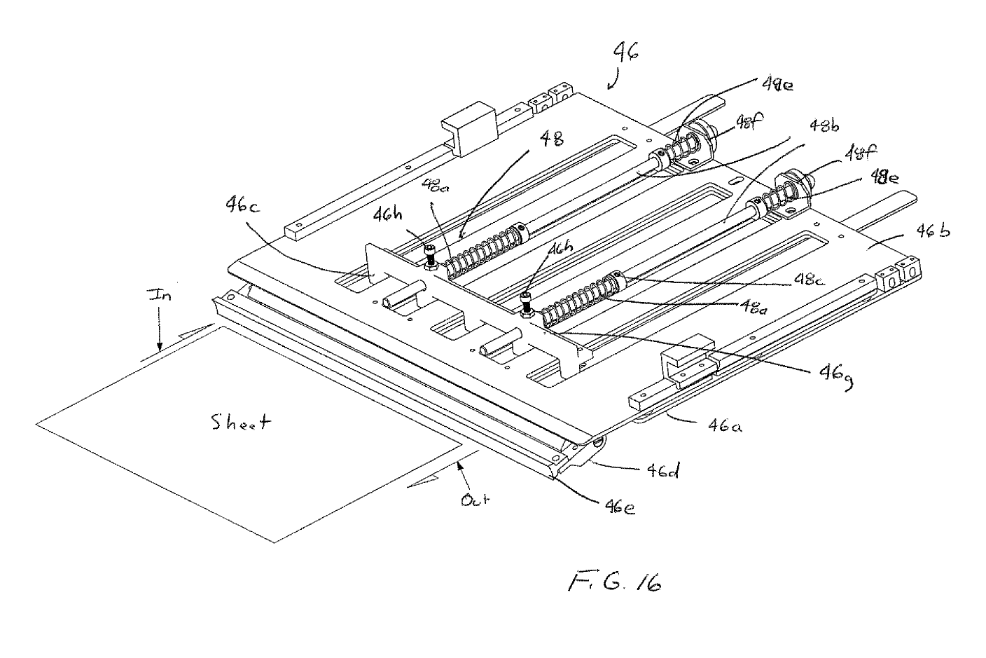

An example of a bucket folder 46 is shown in detail in FIG. 16. Opposing buckle plates 46a, 46b receive at least one sheet forming a page set. The deflector 46d is pivotably mounted on one of the buckle plates 46a and the deflector is normally in a position to deflect the sheet or page set away from a buckle folder. It is pivoted out of position adjacent the buckle fold drive rollers to allow a page set to enter the buckle folder 46. The specific design of this deflector is somewhat different than that shown in previous figures, but includes the end deflector portion 46e and pivoting section. In this example, this bucket folder corresponds to the third bucket folder 46 corresponding to a fourth “plate” when the knife folder 26 may be considered the first plate or series of plates. In this example, the buckle folder 46 includes an end stop 46c formed as an end stop bar 46g. The page set engages the end stop 46c such that the page set buckles into adjacent buckle fold drive rollers and forms a buckle fold.

A biasing mechanism 48 engages the end stop bar 46g to allow biasing movement of the end stop bar as the page set engages the end stop 46c to assist movement of the page set in and out of the bucket folder 46. In an example, this biasing mechanism 48 is formed as a coil spring 48a that engages a protrusion on the end stop 46g. In the illustrated example, two support rods 48b support the end stop bar 46g for movement along the support rod 48g. The coil springs 48a engage the protrusions on the rear side of the end stop bar opposite the side to which the page set engages. An adjusting collar 48c engages the coil spring 48a and can be adjusted to adjust tension of the coil spring 48a against the end stop bar 46g.

As a sheet enters the buckle folder 46, it engages the end stop 46c and biases the end stop bar 46g slightly against the coil spring 48a, which then exerts a force back onto the end stop bar 46g to assist movement of the page set in and out of the buckle folder 46. Thus, the page set will “bounce” out of the buckle folder. By moving the adjusting collars 48c one-eighth, one-fourth, or half an inch, the coil spring tension can be varied. With a thicker package forming a multiple page set, more coil spring compression may be required to bounce the page set out from the buckle folder. The adjusting collar 48c may be moved on the rods an amount sufficient to impart greater tension. A smaller number of pages, such as a two-page set, would require less compression of the coil spring 48a. A pair of rear coil springs 48e exert pressure against rear rod supports 48f. Compression is varied by moving the adjusting collar 48g so that there is some movement and compressive force applied against the rear rod support 48f. At very high feed speeds, this provides some control and resilience.

A nylon screw 46h is formed as a gib in the end stop bar 46g and adjusts the gap within the opening in the end stop bar that receives the support rod 48b. The end stop bar 46g remains in a desired position without excessive “slop” and clearance. This nylon screw 46h can be made of any suitable material but nylon has been found useful as a gib material.

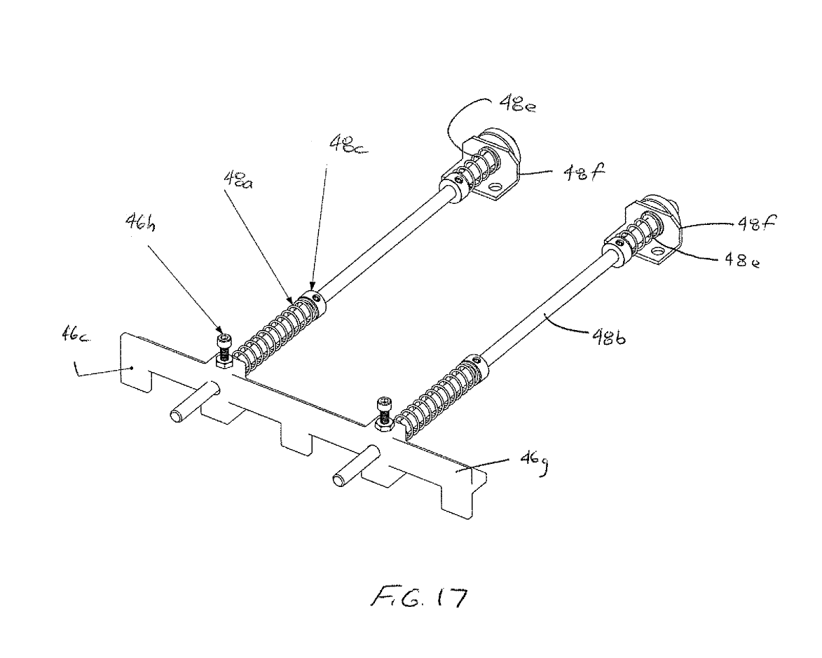

FIG. 17 is an enlarged isometric view of the end stop bar 46g, support rods 48b, and coil springs 48a showing details as shown in FIG. 16. This biasing mechanism can be applied to one or more buckle rollers depending on registration and address location requirements, such as location on the trailing edge of the sheet in this example.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A folding machine, comprising:
an accumulator that accumulates at least one sheet of flexible substrate material;
a knife folder adjacent the accumulator and having a knife fold plate that receives the at least one sheet and a knife blade that reciprocates against the at least one sheet;
buckle fold drive rollers adjacent the knife folder that receive the at least one sheet driven from the knife blade to form a knife fold; and
at least one buckle folder oriented along the buckle fold drive rollers the receives the knife fold to form a buckle fold in the at least one sheet, the at least one buckle folder including an end stop onto which the at least one sheet engages such that the at least one sheet buckles into adjacent buckle fold drive rollers and forms a buckle fold, and a biasing mechanism engaging the end stop to allow biasing movement of the end stop as the at least one sheet engages the end stop to assist movement of the at least one sheet in and out of the buckle folder.

2. The folding machine according to claim 1, wherein said biasing mechanism comprises a spring engaging the end stop.

3. The folding machine according to claim 1, wherein said end stop comprises an end stop bar onto which the at least one sheet engages as the sheet enters the buckle folder.

4. The folding machine according to claim 3, further comprising at least one rod supporting the end stop bar for movement along the rod.

5. The folding machine according to claim 1, wherein more than one sheet is accumulated against the knife fold plate to form a page set that is knife folded into the buckle fold drive rollers.

6. The folding machine according to claim 5, further comprising a first collector into which the page set is collected after folding.

7. The folding machine according to claim 6, further comprising a second collector into which at least one sheet as a subset folded separately from the page set is collected.

8. The folding machine according to claim 7, wherein the first and second collectors are configured to merge the subset with the page set.

9. The folding machine according to claim 1, further comprising a plurality of buckle folders oriented along the buckle fold drive rollers that are selected to receive and fold the at least one sheet to form successive buckle folds.

10. The folding machine according to claim 9, wherein each buckle folder comprises a pivotably mounted deflector normally in a position to deflect a sheet from entering a respective buckle folder and pivoted to allow a sheet to enter a buckle folder.

11. The folding machine according to claim 9, and wherein each buckle folder comprises opposing buckle plates that receive the at least one sheet and a deflector pivotably mounted on one of the buckle plates that is normally in a position to deflect a sheet away from a buckle folder and pivoted out of position adjacent the buckle fold drive rollers to allow a sheet to enter the buckle folder.

12. The folding machine according to claim 1, and further comprising a shuttle that separates a plurality of sheets into the accumulator.

13. A folding machine, comprising:
an accumulator that accumulates a plurality of sheets of flexible substrate material to form a page set;
a knife folder adjacent the accumulator and having a knife fold plate that receives the page set and a knife blade that reciprocates against the page set;
buckle fold drive rollers positioned offset to each other and adjacent the knife folder that receive the page set driven from the knife blade to form a knife fold;
a plurality of buckle folders oriented along buckle fold drive rollers and at least one configured to receive the knife fold and form a buckle fold in the page set, wherein each buckle folder comprises opposing buckle plates that receive a page set, an end stop that causes the page set to buckle into adjacent buckle fold drive rollers and form a buckle fold and a biasing mechanism engaging the end stop to allow biasing movement of the end stop as the page set engages the end stop to assist movement of the page set in and out of the buckle folder; and
a deflector pivotably mounted on one of the buckle plates that is normally in a position to deflect a sheet away from a buckle folder and pivoted out of position adjacent the buckle fold drive rollers to allow a page set to enter the buckle folder.

14. The folding machine according to claim 13, wherein said biasing mechanism comprises a spring engaging the end stop.

15. The folding machine according to claim 13, wherein said end stop comprises an end stop bar onto which the page set engages as it enters the buckle folder.

16. The folding machine according to claim 15, further comprising at least one rod supporting the end stop bar for movement along the rod.

17. The folding machine according to claim 13, and further comprising a first collector into which the page set is collected.

18. The folding machine according to claim 17, and further comprising a second collector into which at least one sheet folded separately as a subset from the page set is collected.

19. The folding machine according to claim 18, wherein the first and second collectors are configured to merge the subset with the page set.

20. The folding machine according to claim 13, and further comprising a shuttle that separates a plurality of sheets into the accumulator to form the page set.

21. A method of folding sheets of flexible substrate material, comprising:
feeding at least one sheet against a knife fold plate;
driving a knife against the at least one sheet into buckle fold drive rollers to form a knife fold; and
driving the knife fold using the buckle fold drive rollers into at least one buckle folder to form a buckle fold while engaging the at least one sheet against an end stop within the buckle folder and biasing the end stop for assisting movement of the least one sheet in and out of the buckle folder.

22. The method according to claim 21, wherein the biasing mechanism comprises a spring.

23. The method according to claim 21, wherein the end stop comprises an end stop bar onto which the sheets engage as the sheets enter the buckle folder.

24. The method according to claim 23, further comprising at least one rod supporting the end stop bar for movement along the rod.

25. The method according to claim 21, further comprising accumulating more than one sheet against the knife fold plate to form a page set that is knife folded into the buckle fold drive rollers.

26. The method according to claim 25, and further comprising collecting the page set into a first collector.

27. The method according to claim 26, and further comprising folding separately at least one sheet as a subset and collecting the subset at a second collector.

28. The method according to claim 27, and further comprising merging the subset with the page set.

29. The method according to claim 21, and further comprising orienting a plurality of buckle folders along the buckle fold drive rollers and folding the at least one sheet within at least one selected buckle folder to form successive buckle folds.

30. The method according to claim 29, and further comprising selecting a buckle folder to receive at least one sheet by pivoting a deflector away from adjacent the buckle fold drive rollers to allow a sheet to pass into the buckle folder.

31. The method according to claim 30, and further comprising forming each buckle folder as opposing buckle plates that receive at least one sheet and a deflector pivotably mounted on one of the buckle plates that is normally in a position to deflect a sheet away from a buckle folder and pivoted out of position adjacent the buckle fold drive rollers to allow the at least one sheet to enter a buckle folder.

32. The method according to claim 21, and further comprising a shuttle that separates a plurality of sheets into the accumulator.
